(19) United States
(12) Patent Application Publication
(10) Pub. No.: US 2018/0212224 A1
(43) Pub. Date: Jul. 26, 2018

(54) WIRING MODULE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Osamu NAKAYAMA, Yokkaichi, Mie (JP); Katsushi MIYAZAKI, Yokkaichi, Mie (JP); Seishi KIMURA, Yokkaichi, Mie (JP)

(21) Appl. No.: 15/744,146

(22) PCT Filed: Jun. 30, 2016
(86) PCT No.: PCT/JP2016/069379

§ 371 Date: Jan. 12, 2018

(30) Foreign Application Priority Data
Jul. 16, 2015 (JP) 2015-141985

(51) Int. Cl. H01M 2/20; H01G 11/76; H01M 2/10; H01G 2/04

(52) U.S. Cl. CPC H01M 2/206; H01G 11/76; H01M 2220/20; H01G 2/04; H01M 2/1077

(57) ABSTRACT

A wiring module includes: a connection member that electrically connects adjacent positive and negative electrode terminals of a plurality of power storage elements that include the electrode terminals; and an insulating protector in which the connection member is arranged and that is attached to the plurality of power storage elements. Through holes are formed through the connection member, and the insulating protector includes locking portions that can lock to hole edge portions of the through holes.

### CROSS REFERENCE TO RELATED APPLICATIONS

This application claims the priority of Japanese patent application JP2015-141985 filed on Jul. 16, 2015, the entire contents of which are incorporated herein.

### Technical Field

The present specification discloses a technique relating to a wiring module.

### Background Art

A battery module for a vehicle such as an electric automobile or a hybrid automobile has multiple single-cell batteries that include positive and negative electrode terminals and are connected in series or in parallel due to adjacent electrode terminals of the single-cell batteries being connected by bus bars. Here, in order to simplify the task of attaching the bus bars or the like, a wiring module in which bus bars are housed in a protector made of synthetic resin is attached to a battery module in some cases. In Patent Document 1 (JP2013-157125A), terminal fixing portions are arranged in a line on a case main body made of synthetic resin, and coupling terminals are fixed to the terminal fixing portions due to positioning ribs provided on the terminal fixing portions being inserted into positioning recessed portions provided on the circumferential edges of the coupling terminals.

### SUMMARY

Incidentally, as with Patent Document 1, in a configuration in which the positioning recessed portions are provided on the circumferential edges of the coupling terminals and the positioning ribs that are inserted into the positioning recessed portions are provided in a protruding manner on the walls of terminal housing chambers in the terminal fixing portions, modification of the shape of the walls surrounding the circumferential edges of the coupling terminals or the like is needed. However, there are cases where it is not easy to provide a configuration for positioning the positioning ribs or the like in the periphery of the circumferential edges of the coupling terminals from the viewpoint of reducing the size of the wiring module and from the viewpoint of the insulating property of the wiring module.

The present design was completed based on the foregoing circumstance and aims to provide a wiring module according to which it is possible to restrict movement of a connection member with respect to an insulating protector without using a circumferential edge of a connection member.

A wiring module of the present design includes: a connection member that electrically connects adjacent positive and negative electrode terminals of a plurality of power storage elements that include the electrode terminals; and an insulating protector in which the connection member is arranged and that is attached to the plurality of power storage elements, wherein a through hole is formed through the connection member, and the insulating protector includes a locking portion that can lock to a hole edge portion of the through hole.

According to the present configuration, it is possible to restrict movement of the connection member with respect to the insulating protector due to the locking portion of the insulating protector being locked to the hole edge portion of the through hole. Accordingly, it is possible to restrict movement of the connection member with respect to the insulating protector without using the circumferential edge of the connection member.

The following aspects are preferable as embodiments of the present design.

The locking portion has a locking piece that restricts separation of the connection member from the insulating protector in a direction intersecting a plane of the connection member.

The locking portion includes the locking piece and a restricting portion that restricts movement of the connection member in the plane, and the restricting portion and the locking piece can lock to the hole edge portion of the same through hole.

In this manner, it is possible to restrict separation and movement of the connection member using the same through hole.

The through hole is provided so as to pass through a central portion in a connection direction of the connection member.

In this manner, the region of the connection member that is not used for connection with the electrode terminals can be used to restrict the movement of the connection member.

A plurality of said locking portions are included, a plurality of said through holes are formed on one said connection member, and the locking portions lock to the hole edge portions of the through holes.

In this manner, the multiple locking portions of one connection member can lock to the hole edge portions of the multiple through holes, and therefore, for example, movement of the connection member in one direction can be restricted by one locking portion and movement in a direction different from the one direction (the direction opposite to the one direction) can be restricted by another locking portion, and therefore it is possible to increase the degree of freedom in the design. Also, the accuracy of positioning can be increased in comparison to a configuration in which one locking portion is locked for one connection member.

According to the present design, it is possible to restrict movement of a connection member with respect to an insulating protector without using a circumferential edge of the connection member.

### BRIEF DESCRIPTION OF DRAWINGS

FIG. 1 is a plan view showing a power storage module.

FIG. 2 is a cross-sectional view taken along line A-A in FIG. 1.

FIG. 3 is a plan view showing multiple power storage elements.

FIG. 4 is a side view showing a power storage element.

FIG. 5 is a plan view showing a wiring module.

FIG. 6 is a cross-sectional view taken along line B-B in FIG. 5.

FIG. 7 is a cross-sectional view taken along line C-C in FIG. 5.

FIG. 8 is a plan view showing a connection member.

FIG. 9 is a side view showing a connection member.

FIG. 10 is a plan view showing an insulating protector.

FIG. 11 is a cross-sectional view taken along line D-D in FIG. 10.

FIG. 12 is a cross-sectional view taken along line E-E in FIG. 10.

### DESCRIPTION OF EMBODIMENTS

### Embodiment 1

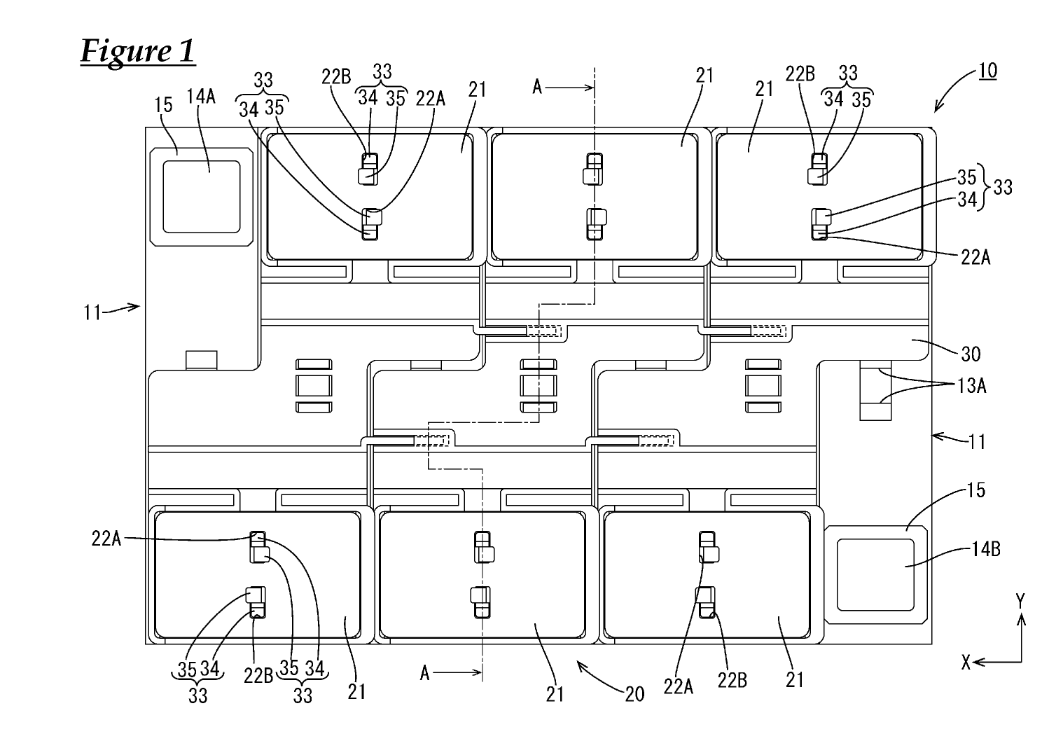

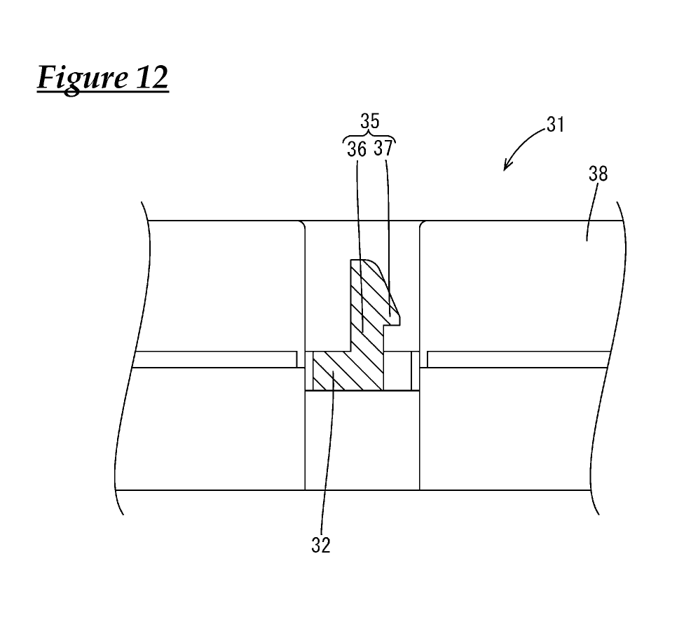

Embodiment 1 will be described with reference to FIGS. 1 to 12.

A power storage module 10 of the present embodiment is mounted in a vehicle such as an electric automobile or a hybrid automobile, for example, and is used as a power source for driving the vehicle. Hereinafter, a description will be given with the X direction being leftward, the Y direction being frontward, and the Z direction being upward.

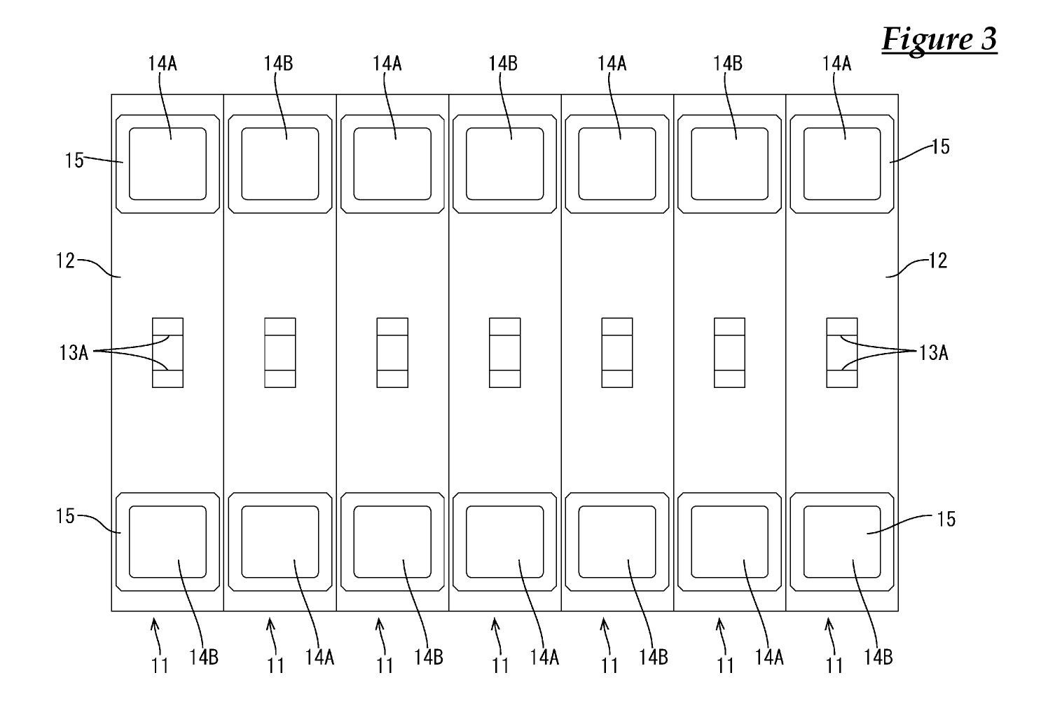

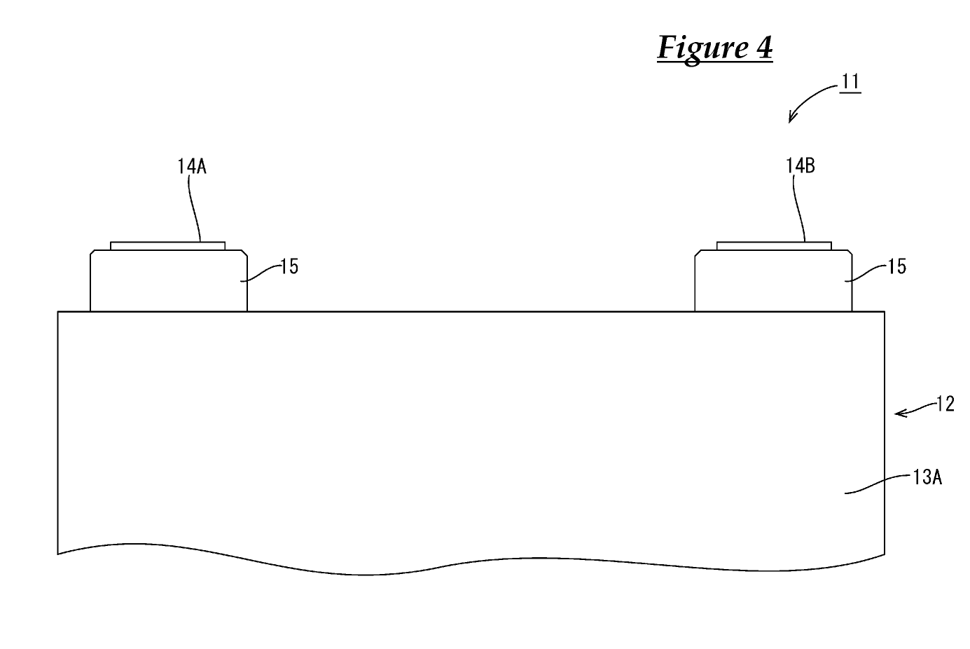

As shown in FIG. 1, the power storage module 10 includes multiple (in the present embodiment, seven) power storage elements 11, and a wiring module 20 that is attached to the multiple power storage elements 11. As shown in FIG. 3, the multiple power storage elements 11 constitute a power storage element group by being aligned in the left-right direction. As shown in FIG. 4, the power storage elements 11 each include a main body portion 12 and electrode terminals 14A and 14B (the cathodes are denoted by 14A and the anodes are denoted by 14B) that protrude from one surface of the main body portion 12. With the main body portion 12, a power storage component (not illustrated) is housed inside of a case 13 made of synthetic resin or metal. The outer circumferences of the electrode terminals 14A and 14B are each covered by an insulating outer covering portion 15 in a rectangular cylindrical shape, and the metal of the leading end portions are exposed above the outer covering portions 15.

The orientations of the adjacent power storage elements 11 are arranged such that the polarities of the adjacent electrode terminals 14A and 14B are opposite. The electrode terminals 14A and 14B located on the end portions in a series connection are connected to a device such as an external inverter via a wire (not shown). The multiple power storage elements 11 are fixed using a holding plate (not shown).

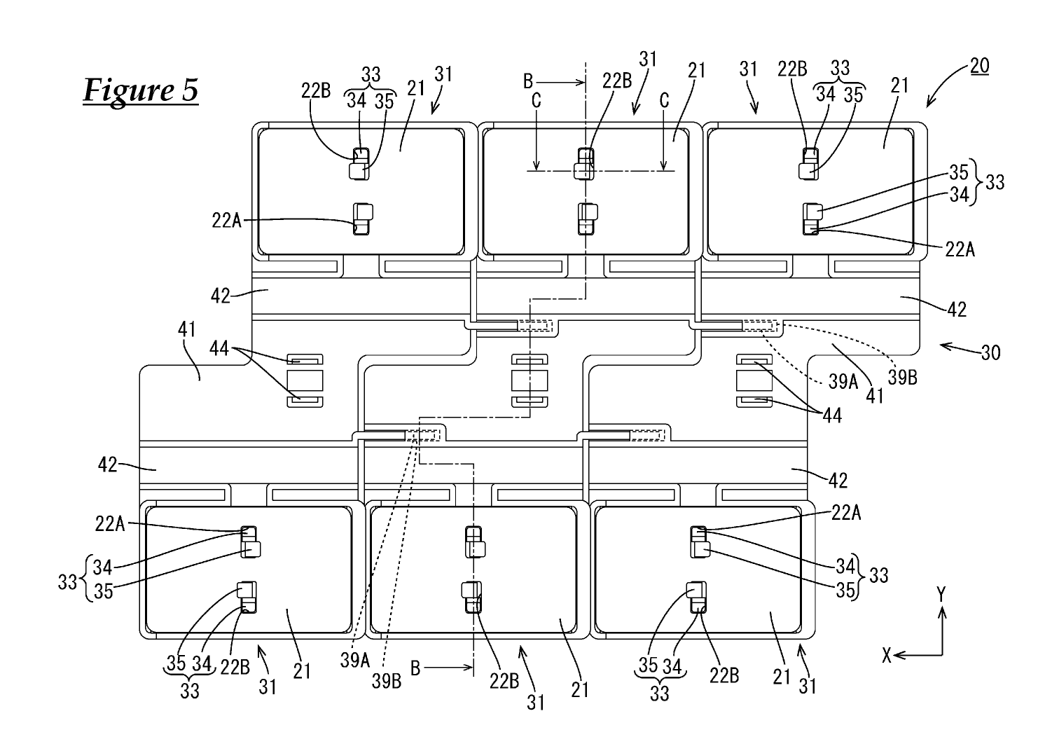

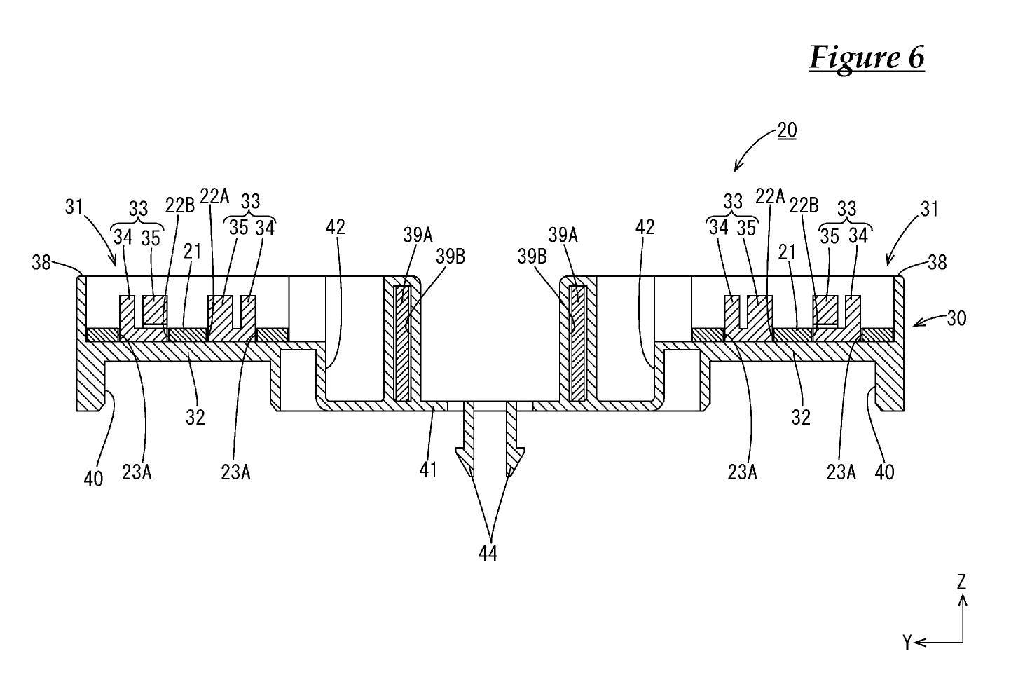

As shown in FIGS. 5 and 6, the wiring module 20 is constituted by including multiple (in the present embodiment, six) connection members 21 that connect adjacent electrode terminals 14A and 14B, and an insulating protector 30 that houses the multiple connection members 21.

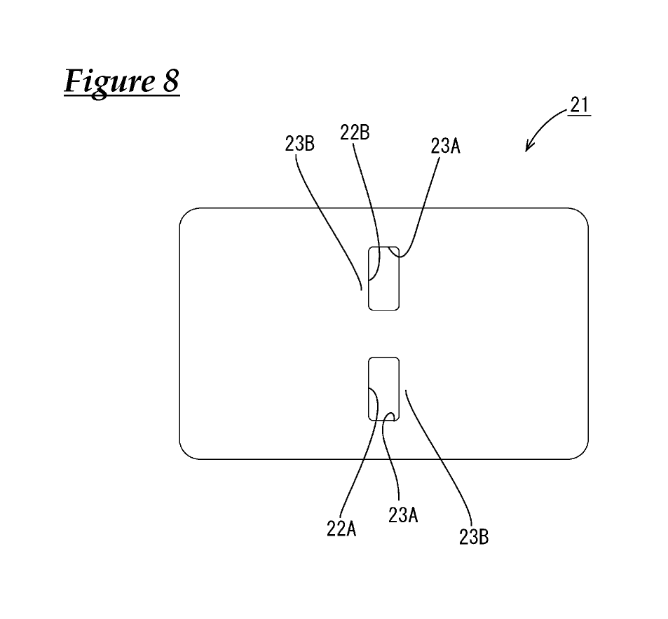

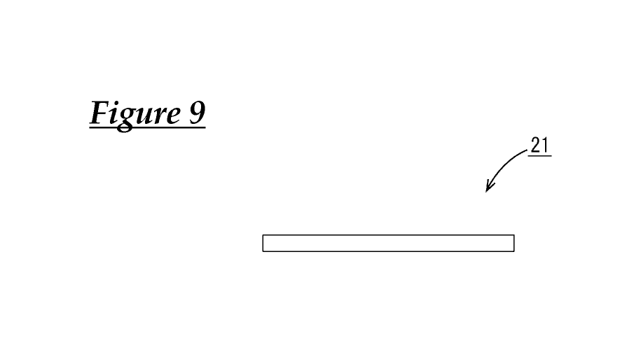

As shown in FIGS. 8 and 9, each connection member 21 is rectangular plate-shaped, and for example, is composed of a metal such as copper, a copper alloy, aluminum, an aluminum alloy, or stainless steel (SUS). A pair of through holes 22A and 22B are formed so as to penetrate through the central portion in the left-right direction of each connection member 21 (the central portion in the connection direction of the connection member). The through holes 22A and 22B are provided with a gap therebetween in the front-rear direction (the direction orthogonal to the connection direction of the connection member 21 on the plate surface (plane) of the connection member 21), and are both rectangular shapes that are longer in the front-rear direction. With the connection member 21, the rectangular leading end surfaces of the electrode terminals 14A and 14B overlap with the regions on both the left and right sides of the through holes 22A and 22B and are welded through laser welding. Accordingly, the electrode terminals 14A and 14B are electrically connected via the connection member 21.

Note that voltage detection terminals (not shown) for detecting the voltages of the power storage elements 11 may be overlaid on the connection members 21. The wires connected to the voltage detection terminals are connected to an external ECU (Electronic Control Unit) (not shown). The ECU is provided with a microcomputer, an element, and the like, and has a known configuration that includes a function for performing detection of voltages, currents, and temperatures of the power storage elements 11, and controlling charging and discharging of the power storage elements 11.

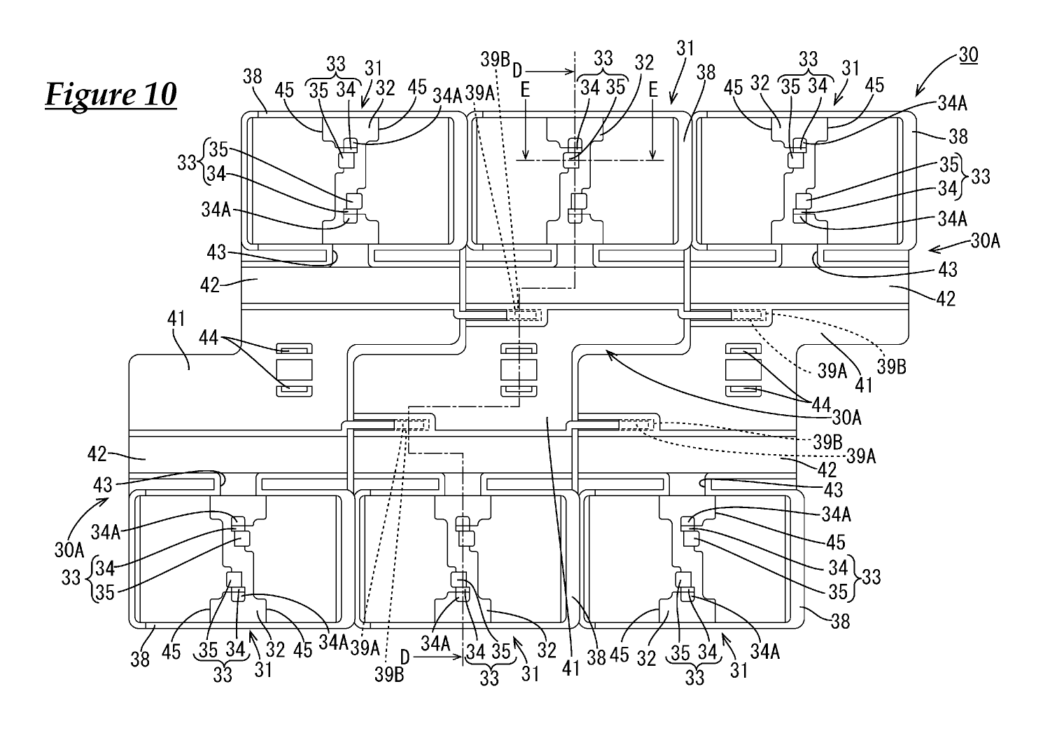

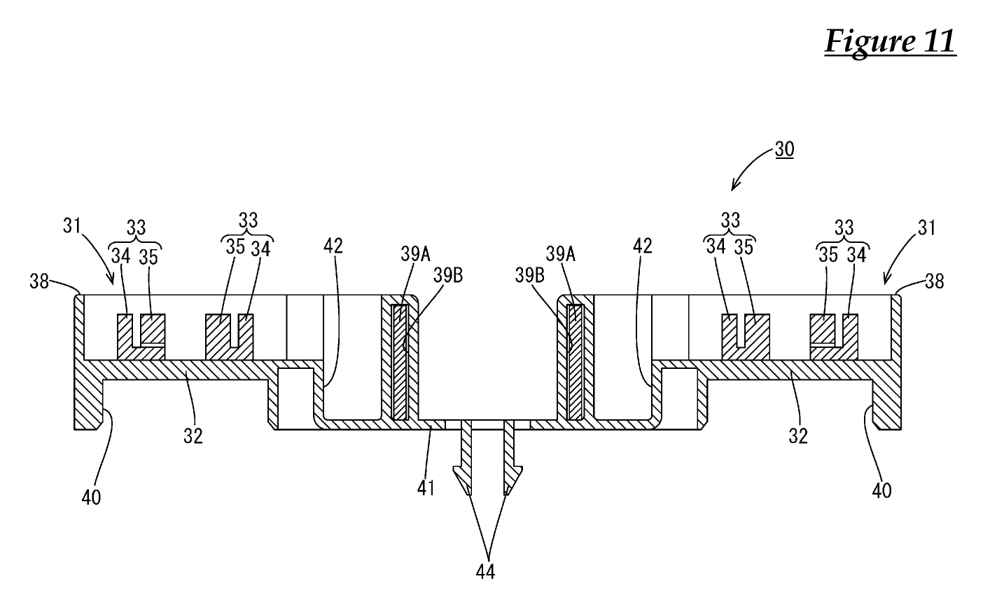

The insulating protector 30 is composed of insulating synthetic resin, and as shown in FIGS. 10 and 11, is constituted by coupling multiple (in this embodiment, three) coupling units 30A in the left-right direction, and includes multiple (in this embodiment, six) arrangement portions 31 in which the connection members 21 are arranged aligned in two front and rear rows, and multiple (in this embodiment, three in the left-right direction) connection portions 41 that connect the arrangement portions 31 in the different rows. The coupling units 30A each include a front and rear pair of arrangement portions 31 and a connection portion 41 that couples the pair of arrangement portions 31.

The arrangement portions 31 each include opposing portions 32 on which the connection member 21 can be installed such that the bottom surfaces (the surfaces on the power storage element side) of the connection members 21 oppose the opposing portions 32, and partitioning walls 38 that surround the connection members 21 in the form of rectangular cylinders. The opposing portions 32 extend in the form of plates so as to overlap with the central portions in the left-right direction of the connection members 21. Both the left and right edges of the opposing portions 32 are cut out according to the positions of later-described locking portions 33. Opening portions 45 through which the electrode terminals 14A and 14B pass are set on the left and right of the opposing portions 32. The opposing portions 32 each include two (multiple) locking portions 33 that protrude upward (toward the connection members 21) and can lock to hole edge portions 23A and 23B of the through holes 22A and 22B of the connection members 21.

The locking portions 33 at the two locations in the front and rear both include restricting portions 34 and locking pieces 35, which are arranged at positions adjacent to each other. Each restricting portions 34 protrudes upward in a rectangular shape and has a rectangular cross-section of such a size that it can fit into a region corresponding to half the distance in the front-rear direction of the through holes 22A and 22B. On the upper end portions (leading end portions) of the front and rear pair of restricting portions 34, tapered portions 34A that are inclined such that the outer sides (the front end side of the front-side restricting portion 34 and the rear end side of the rear-side restricting portion 34) are lower are formed. The insertion of the restricting portions 34 into the through holes 22A and 22B is guided by the tapered portions 34A at the time of attaching the connection member 21. When the restricting portions 34 are inserted into the through holes 22A and 22B to the proper position, the tapered portions 34A are arranged above the upper ends of the through holes 22A and 22B. Due to the front and rear pairs of restricting portions 34 being fit into the regions outside of the pair of through holes 22A and 22B, the positions of the connection members 21 with respect to the opposing portions 32 on the plane (the positions in the front-rear direction and the left-right direction) are determined.

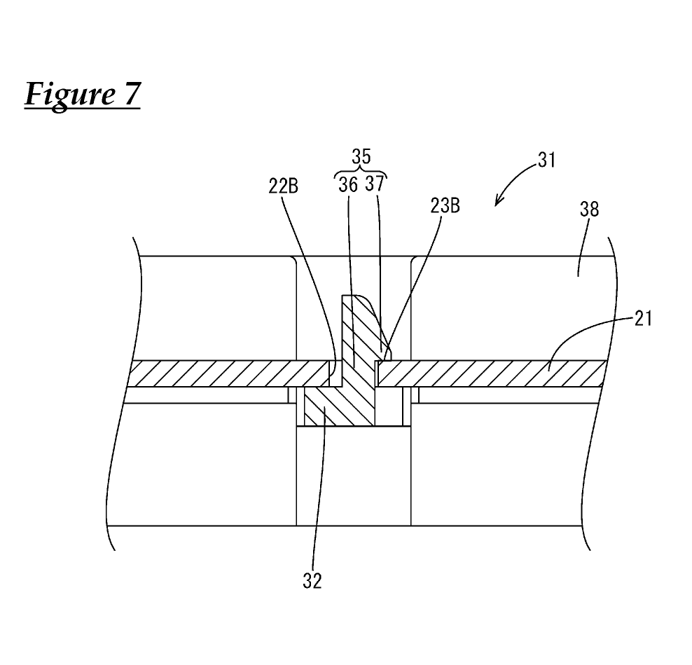

The locking pieces 35 are provided inward of the restricting portions 34, and as shown in FIG. 7, include bendable bending portions 36 that can stand upright in a direction orthogonal to the surfaces of the opposing portions 32, and protruding portions 37 that protrude in the form of level differences from the leading end portions of the bending portions 36 in a direction orthogonal to the extension direction of the bending portions 36 (an intersecting direction). The locking pieces 35 are inserted into regions of the through holes 22A and 22B of the connection members 21 into which the restricting portions 34 are not inserted, and the locking pieces 35 inserted in the different through holes 22A and 22B are arranged in orientations in which the protruding portions 37 protrude in opposite directions to each other with respect to the bending portions 36 (back-to-back orientation).

When the locking pieces 35 are inserted into the through holes 22A and 22B with the bending portions 36 bent and the connection members 21 are arranged on the opposing portions 32, the bending portions 36 perform a righting deformation and the level difference surfaces of the protrusion portions 37 oppose the hole edge portions 23B of the connection members 21. Accordingly, even if the connection members 21 are biased upward, the connection members 21 are locked to the protruding portions 37 and upward separation is restricted.

As shown in FIGS. 10 and 11, the coupling units 30A each include plate-shaped coupling portions 39A that are inserted into insertion holes 39B of an adjacent coupling unit 30A so as to couple the adjacent coupling unit 30A. When the multiple coupling units 30A are coupled, the arrangement portions 31 in two rows with shifted positions in the alignment direction are formed.

Fitting portions 40 into which the electrode terminals 14A and 14B are fit are provided on the underside surfaces of the arrangement portions 31, and the insulating protector 30 is positioned on the power storage elements 11 by fitting the fitting portions 40 on the outer covering portions 15 of the electrode terminals 14A and 14B.

The connection portions 41 include groove portions 42 in two front and rear rows, and plate-shaped portions that couple the groove portions 42 in the two rows. For example, the groove portions 42 extend along the alignment direction of the arrangement portions 31 such that wires connected to the voltage detection terminals can pass therethrough, and pairs of groove walls stand upright from the groove bottoms. The groove portions 42 and the arrangement portions 31 are coupled by groove-shaped communication portions 43, and wires for voltage detection can be passed through the groove portions 42 from the connection member 21 side via the communication portions 43.

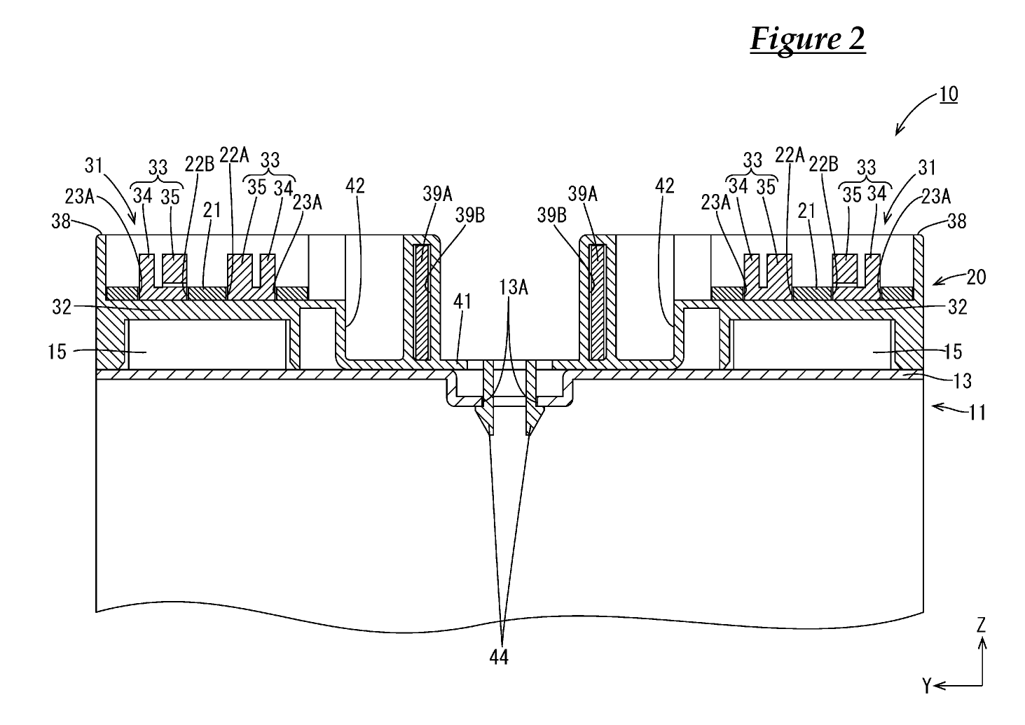

Pairs of bending attachment pieces 44 protrude downward at the plate-shaped portions of the connection portions 41. The pairs of attachment pieces 44 are arranged parallel to each other in a back-to-back orientation, and claw portions are formed on the leading ends thereof. As shown in FIG. 2, the claw portions of the attachment pieces 44 are locked to the hole edges of rectangular locked holes 13A that are formed through sunken portions in the upper surfaces of the cases 13 of the power storage elements 11, and thereby the insulating protector 30 is attached and fixed to the power storage elements 11.

Next, attachment of the power storage module 10 will be described.

The insulating protector 30 is formed by coupling the coupling units 30A (FIG. 10). Then, the restricting portions 34 and the locking pieces 35 of the arrangement portions 31 are inserted into the through holes 22A and 22B of the multiple connection members 21 so as to lock to the hole edge portions 23A and 23B of the connection members 21. Accordingly, the wiring module 20 is formed (FIG. 5). Next, the wiring module 20 is mounted on the power storage element group obtained by aligning the multiple power storage elements 11. Then, the connection members 21 are connected to the electrode terminals 14A and 14B through laser welding. Accordingly, the power storage module 10 is formed (FIG. 1).

According to the present embodiment, the following actions and effects are displayed.

According to the present embodiment, the locking portions 33 of the insulating protector 30 are inserted into the through holes 22A and 22B and lock to the hole edge portions 23A and 23B of the through holes 22A and 22B, and thereby it is possible to restrict the movement of the connection member 21 with respect to the insulating protector 30. Accordingly, it is possible to restrict the movement of the connection member 21 with respect to the insulating protector 30 without using the circumferential edge of the connection member 21.

Also, in a direction intersecting the plane of the connection member 21, the locking portions 33 include locking pieces 35 that restrict the separation of the connection member 21 from the insulating protector 30.

In this manner, it is possible to restrict separation of the connection member 21 in the direction intersecting the plane of the connection member 21 using the locking pieces 35.

Also, each locking portion 33 includes a locking piece 35 and a restricting portion 34 that determine the position of the connection member 21 on the plane, and the restricting portion 34 and locking piece 35 can lock to the hole edge portions 23A and 23B of the same through hole 22A or 22B.

In this manner, it is possible to restrict separation and movement of the connection member 21 by using the same through holes 22A and 22B.

Also, the through holes 22A and 22B are provided so as to pass through the central portion in the connection direction of the connection member 21.

In this manner, the regions of the connection member 21 that are not being used to connect the electrode terminals 14A and 14B can be used to restrict the movement of the connection member 21, and therefore space can be used effectively.

Also, multiple locking portions 33 are included, multiple through holes 22A and 22B are formed on one connection member 21, and the locking portions 33 lock to the hole edge portions 23A and 23B of the through holes 22A and 22B.

In this manner, multiple locking portions 33 can lock to the hole edge portions 23A and 23B of the multiple through holes 22A and 22B of one connection member 21. Accordingly, for example, movement of the connection member 21 in one direction can be restricted by one locking member 33, and movement in a direction different to the one direction (the direction opposite to the one direction) can be restricted by the other locking portion 33, and therefore it is possible to increase the degree of freedom in the design. Also, the accuracy of positioning can be increased in comparison to a configuration in which one locking portion 33 is locked for one connection member 21.

### Other Embodiments

The present invention is not limited to the embodiment described in the above description and drawings, and for example, the following embodiments are encompassed in the technical scope of the present invention as well.

In the above-described embodiment, the connection members 21 are connected to the electrode terminals 14A and 14B through laser welding, but there is no limitation to this. For example, ultrasonic welding, resistance welding, or the like can be used. Also, there is no limitation to welding, and another fixing means may be used. For example, bolts and nuts may be used as the fixing means, through holes for bolts may be formed through plate-shaped connection members made of metal, and bolt-shaped electrode terminals 14A and 14B may be passed through the through holes of the connection members and fastened with nuts, or shaft portions of bolts may be passed through through holes in the connection members and fastened to nut-shaped electrode terminals.

The number of power storage elements 11 constituting the power storage module 10 is not limited to the number described in the embodiment above and can be set to any number. Also, the size of the wiring module 20, the number of connection members 21, and the like can be set as appropriate according to the number of power storage elements 11.

Although the power storage elements 11 were batteries, there is no limitation thereto, and capacitors or the like may be used thereas.

The positions of the hole edge portions 23A (hole wall surfaces) and the hole edge portions 23B (vicinities of the through holes) of the through holes 22A and 22B are not limited to being the positions described in the embodiment above, and positions that can be locked to can be used as the hole edge portions of the through holes 22A and 22B according to the positions and sizes of the restricting portion 34 and the protruding portions 37 of the locking pieces 35.

Although the opposing portions 32 had a configuration in which the connection members 21 were mounted thereon, the opposing portions 32 may oppose the connection members 21 with gaps provided therebetween.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10 Power storage module

11 Power storage element

14A, 14B Electrode terminal

20 Wiring module

21 Connection member

22A, 22B Through hole

23A, 23B Hole edge portion

30 Insulating protector

32 Opposing portion

33 Locking portion

34 Restricting portion

35 Locking piece

1. A wiring module, comprising:
a connection member that electrically connects adjacent positive and negative electrode terminals of a plurality of power storage elements that include the electrode terminals; and
an insulating protector in which the connection member is arranged and that is attached to the plurality of power storage elements,
wherein a through hole is formed through the connection member, and
the insulating protector includes a locking portion that can lock to a hole edge portion of the through hole.

2. The wiring module according to claim 1, wherein the locking portion has a locking piece that restricts separation of the connection member from the insulating protector in a direction intersecting a plane of the connection member.

3. The wiring module according to claim 2, wherein the locking portion includes the locking piece and a restricting portion that restricts movement of the connection member in the plane, and the restricting portion and the locking piece can lock to the hole edge portion of the same through hole.

4. The wiring module according to claim 1, wherein the through hole is provided so as to pass through a central portion in a connection direction of the connection member.

5. The wiring module according to claim 1, comprising:
a plurality of said locking portions,
wherein a plurality of said through holes are formed on one said connection member, and the locking portions lock to the hole edge portions of the through holes.
